(19) United States
(12) Patent Application Publication
(10) Pub. No.: US 2015/0227263 A1
(43) Pub. Date: Aug. 13, 2015

(54) PROCESSING A PAGE-TRANSITION ACTION USING AN ACOUSTIC SIGNAL INPUT

(71) Applicant: Kobo Inc., Toronto (CA)

(72) Inventors: James Wu, Newmarket (CA); Yasuyuki Hayashi, Tokyo (JP)

(73) Assignee: Kobo Inc., Toronto (CA)

(21) Appl. No.: 14/179,106

(22) Filed: Feb. 12, 2014

(51) Int. Cl. G06F 3/043; G06F 3/01; G06F 3/0483; G06F 3/16

(52) U.S. Cl. CPC G06F 3/0436; G06F 3/167; G06F 3/016; G06F 3/0483

(57) ABSTRACT

A computing device includes a housing, a display assembly having a screen, and a processor to display at least a portion of an initial page state for a paginated content item. A tactile interface is provided on a surface of the housing to produce a plurality of acoustic signals based on user interactions. An audio input device is provided with a portion of the housing to detect the acoustic signals produced by the tactile interface. The processor is to interpret the plurality of acoustic signals produced by the tactile interface as a plurality of user inputs, respectively, wherein one or more acoustic signals of a first type correspond with a page turn instruction. The processor further responds to acoustic signals of the first type by transitioning from displaying at least the initial page state to displaying another page state as determined by a value or type of the page turn.

### TECHNICAL FIELD

Examples described herein relate to processing a page transition action using an acoustic signal input.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for providing e-book services on a computing device with acoustic input functionality, according to an embodiment.

FIG. 2 illustrates an example of an e-reader device or other electronic personal display device, for use with one or more embodiments described herein.

FIG. 3A is a frontal view of an e-reader device having a tactile acoustic input mechanism, in accordance with some embodiments.

FIG. 3B is a rear view of an e-reader device having a tactile acoustic input mechanism, in accordance with other embodiments.

FIG. 3C is a frontal view of an e-reader device having a tactile acoustic input mechanism, in accordance with other embodiments.

FIG. 3D is a rear view of an e-reader device having a tactile acoustic input mechanism, in accordance with other embodiments.

FIG. 4 illustrates an acoustic interface for detecting and processing acoustic signals, according to one or more embodiments.

FIG. 5 illustrates an e-reader system for displaying paginated content, according to one or more embodiments.

FIG. 6 illustrates a method for displaying paginated content, according to one or more embodiments.

### DETAILED DESCRIPTION

Embodiments described herein provide for a computing device that interprets acoustic signals as input. Some embodiments enable such acoustic signals to be received and interpreted into a page-turning action, such as in context of displaying paginated content such as an e-book. The acoustic signals can correspond to user-generated sounds, for example, made through a housing interface of the computing device. In some embodiments, a user action corresponding to a finger swipe or contact with a tactile interface of a computing device produces acoustic signals that are interpreted as a page-turning instruction.

As used herein, the term “page transition” is intended to mean an action in which a rendered page of content is transitioned to another such page. A given page can be rendered in the form of a card, panel, or window. In the context of e-reading activity, a page transition can correspond to an event in which a page of an e-book is transitioned to another page. By way of examples, page transitions in the context of e-reading activity can refer to transitioning single pages, chapters, or pages by clusters.

Still further, in some embodiments, a computing device includes a housing, a display assembly having a screen, and a processor to display at least a portion of an initial page state for a paginated content item. A tactile interface is provided on a surface of the housing to produce a plurality of acoustic signals based on user interactions. An audio input device is provided with a portion of the housing to detect the acoustic signals produced by the tactile interface. The processor is to interpret the plurality of acoustic signals produced by the tactile interface as a plurality of user inputs, respectively, wherein one or more acoustic signals of a first type correspond with a page transition instruction. The processor further responds to acoustic signals of the first type by transitioning from displaying at least the initial page state to displaying another page state as determined by a value or type of the page turn.

The tactile interface may comprise a plurality of peaks and valleys to produce the plurality of acoustic signals in response to the user interactions. For some embodiments, the plurality of peaks and valleys are configured in a grid pattern that enables the tactile interface to produce different acoustic signals in response to different user interactions. Examples of such user interactions may include finger swipes in one or more directions. For some embodiments, the plurality of peaks and valleys are of varying degree or size such that, when swiped, the tactile interface produces an acoustic signal which indicates a directionality of the swipe.

The processor may interpret the acoustic signal produced by a finger swipe in a first direction as a forward page transition instruction, and respond to the forward page transition instruction by transitioning from displaying the initial page state to displaying a subsequent page state. Further, the processor may interpret the acoustic signal produced by a finger swipe in a second direction as a backward page transition instruction, and respond to the backward page transition instruction by transitioning from displaying the initial page state to displaying a previous page state. For example, the second direction may be opposite the first direction.

For some embodiments, the tactile interface may be provided on a back surface of the housing. Alternatively, or in addition, the tactile interface may be provided on a side surface of the housing. For example, the tactile interface may be superimposed onto the surface of the housing. Alternatively, the tactile interface may be integrally formed with the surface of the housing.

Among other benefits, examples described herein enable a personal display device such as an e-reader device to be equipped with sensors that enable a user to transition through pages of an e-book in a manner that mimics how users flip through the pages of a paperback.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

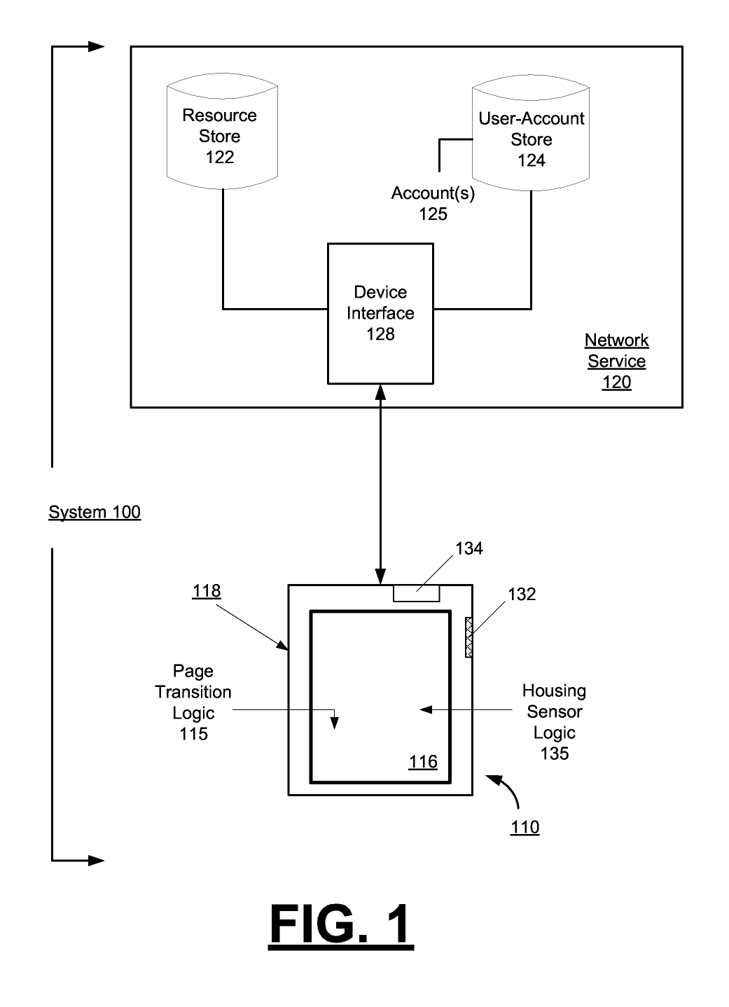

FIG. 1 illustrates a system 100 for providing e-book services on a computing device with acoustic input functionality, according to an embodiment. In an example of FIG. 1, system 100 includes an electronic display device, shown by way of example as an e-reader device 110, and a network service 120. The network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application that receives files or streaming data from the network service 120. By way of example, the e-reader device 110 can be equipped with hardware and software to optimize certain application activities, such as reading electronic content (e.g., e-books). For example, the e-reader device 110 can have a tablet-like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With reference to an example of FIG. 1, e-reader device 110 can include a display screen 116 and a housing 118. In an embodiment, the display screen 116 is touch-sensitive, to process touch inputs including gestures (e.g., swipes). Alternatively, or in addition, the housing 118 can include a tactile interface 132 to produce acoustic signals in response to user interaction. The acoustic signals are indicative of the type of user interaction, and are interpreted by the computing device 110 as user input. In an example of FIG. 1, the tactile interface 132 is provided on a side surface or edge of the housing 118, and/or on a back surface (not shown) of the housing 118. In alternative embodiments, the tactile interface 132 may be separate or detachable from the main housing 118, for example, to provide remote control-type functionality for the e-reader device 110.

In some embodiments, the e-reader device 110 includes features for providing and enhancing functionality related to displaying paginated content. The e-reader device can include page transitioning logic 115, which enables the user to transition through paginated content. The e-reader device can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the tactile interface 132. For example, the user can swipe the tactile interface 132 in a particular direction (e.g., up, down, left, or right) to indicate a sequential direction of a page transition. More specifically, when swiped, the tactile interface 132 produces an acoustic signal (i.e., sound) representative of the page transition instruction and/or direction. In variations, the user can specify different kinds of page transitioning input (e.g., single page turns, multiple page turns, chapter turns) through different kinds of input.

For some embodiments, the page turn input of the user can be provided with a magnitude to indicate a magnitude in the transition of the page state (e.g., number of pages transitioned). For example, a user can swipe the tactile interface 132 at faster speeds in order to cause a cluster or chapter page state transition, while a slower swipe can effect a single page state transition (e.g., from one page to a next in sequence). By way of example, the user can provide a first type of input (e.g., slow-normal swiping motion in a vertical direction) through the tactile interface 132 to signify a single page turn, a second type of input (e.g., face swiping motion in a vertical direction) to signify a mufti-page transition, and/or a third type of input (e.g., swiping in a horizontal direction) to specify a chapter transition. As another example, the user can specify page turns of different kinds or magnitudes by interacting with the touch-sensitive display screen 116 (e.g., through taps, gestures, and/or other types of contact).

According to some embodiments, the e-reader device 110 includes an acoustic interface 134 to detect and interpret user input made through interaction with the tactile interface 132. By way of example, the acoustic interface 134 can detect acoustic signals made through user interaction (e.g., finger swipes) with the tactile interface 132 (which may be superimposed on, or integrally formed with, a region of the housing 118 that is in close proximity to the acoustic interface 134). The acoustic interface 134 can receive or detect the acoustic signals via an audio input device (e.g., microphone), and can interpret the acoustic input in a variety of ways. For example, in the context of an e-book application, acoustic signals of a particular type may correspond with a page turn or page/chapter transition. In a more general context, the acoustic signals can be interpreted by the acoustic interface 134 to perform any number and/or combination of user input commands (e.g., turn the computing device 110 on or off, open or close an e-book, etc.). For some embodiments, the acoustic interface 134 may be dynamically and/or programmatically configured to respond to acoustic signals based on user preference.

Hardware Description

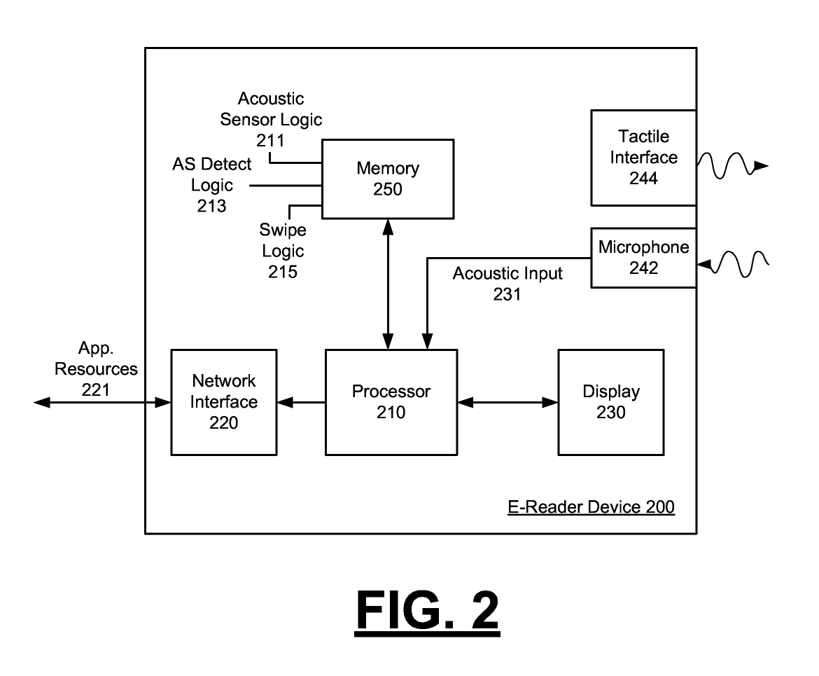

FIG. 2 illustrates an example of an e-reader device 200 or other electronic personal display device, for use with one or more embodiments described herein. In an example of FIG. 2, an e-reader device 200 can correspond to, for example, the device 110 as described above with respect to FIG. 1. With reference to FIG. 2, e-reader device 200 includes a processor 210, a network interface 220, a display 230, a microphone 242, a tactile interface 244, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources 221, such as e-books or media files, that the user elects to purchase or otherwise download from the network service 120. The application resources 221 that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which content is displayed. Examples of such display technologies include electrophoretic displays, electrowetting displays, and electrofluidic displays.

The tactile interface 244 can generate or otherwise produce acoustic signals based on user interactions. For some embodiments, the tactile interface 244 is a mechanical structure provided on a surface of the housing of the e-reader device 200. For example, the tactile interface 244 may be mechanically coupled to (e.g., superimposed on) the surface of the house. Alternatively, the tactile interface may be integrally formed as part of the outer surface of the housing itself. To enable one-handed operation, the tactile interface 244 may be located in an area or region of the housing that is readily accessible (e.g., can be swiped) by the user's finger(s) while holding the device with the same hand. For example, the tactile interface 244 may be provided on a side and/or back surface of the housing.

For some embodiments, the tactile interface 244 produces the acoustic signals by purely mechanical means (i.e., the tactile interface 244 contains no electronic components and/or connections). For example, the tactile interface 244 may be formed from a material (such as aluminum or plastic) that resonates and produces a sound/vibration in response to touch or impact. Specifically, the tactile interface 244 can comprise a number of peaks and/or valleys that produce a series of tones (which may be collaboratively referred to as a “sound”) when swiped (e.g., when touched or contacted in succession). Further, the peaks and valleys may be of varying size, shape, degree, arrangement, and/or pitch (e.g., in a grid pattern) to produce different sounds depending on the direction of swiping. For example, the peaks and valleys may be arranged in decreasing size such that a downward swipe on the tactile interface 244 produces a distinctly different sound (e.g., a decrescendo) than an upward swipe on the interface 244 (e.g., a crescendo). This enables directionality (of the swipe) to be indicated in the acoustic signals produced by the tactile interface 244.

The processor 210 can receive input from various sources, including the microphone 242, the display 230 or other input mechanisms (e.g., buttons, keyboard, mouse, etc.). The microphone 242 can correspond to a non-specialized, multipurpose microphone. For example, the microphone 242 can be an “off-the-shelf” component that is manufactured to receive sound in a wide variety of acoustic spectrums, including those used to detect music and/or voice. With reference to examples described herein, the processor 210 can respond to an acoustic input 231 from the microphone 242. The acoustic input 231 may include any and/or all audio input received or detected by the microphone 242, including, for example, acoustic signals produced by the tactile interface 244. In one embodiment, the processor 210 detects acoustic signals in the acoustic input 231 from the microphone 242, and responds to the acoustic signals in order to facilitate or enhance e-book activities such as page transitioning. By way of example, the acoustic signals can signify a single page turn, multiple page turns, and/or chapter turns (i.e., when the user is performing a page turning action on an e-book).

In some embodiments, the memory 250 stores acoustic sensor logic 211 that monitors for acoustic signals in the acoustic input 231 received via the microphone 222, and further processes the acoustic signals as a particular user input or type of user input. In one implementation, the acoustic sensor logic 211 can be integrated with the microphone 242. For example, the microphone 242 can be provided as a modular component that includes integrated circuits or other hardware logic, and such resources can provide some or all of the acoustic sensor logic 211. For example, integrated circuits of the microphone 242 can monitor for acoustic signals produced by the tactile interface 244 and/or process the acoustic signals as being of a particular kind or type (e.g., corresponding with a page-turning action). In variations, some or all of the acoustic sensor logic 211 is implemented with the processor 210 (which utilizes instructions stored in the memory 250), or with one or more alternative processing resources.

In one implementation, the housing sensor logic 211 includes acoustic signal (AS) detection logic 213 and swipe logic 215. The AS detection logic 213 implements operations to monitor for acoustic signals in the acoustic input 231 picked up by the microphone 242 (e.g., in response to user interaction with the tactile interface 244). The swipe logic 215 detects and correlates a directionality or sound of the acoustic signal (e.g., based on the user swiping the tactile interface 244 in an upward, downward, leftward, or rightward direction) as a particular type of input or user action. The swipe logic 215 can also detect a magnitude or degree of the acoustic signal so as to distinguish between faster and slower swiping motions.

E-Book Housing Configurations

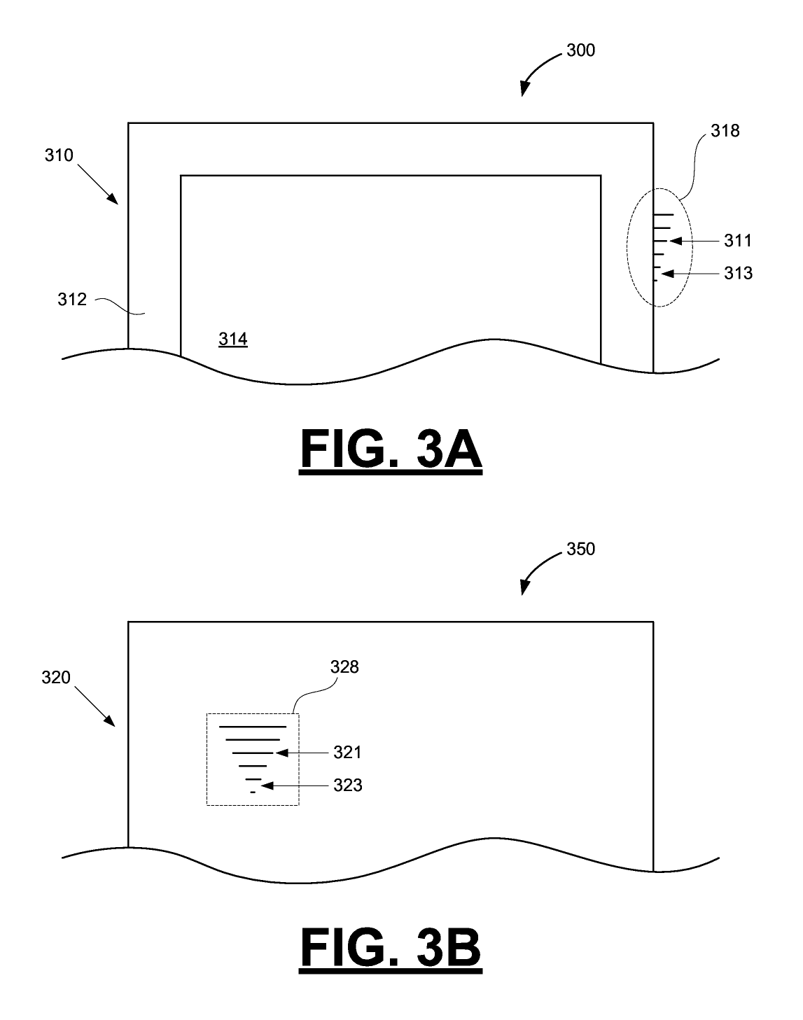

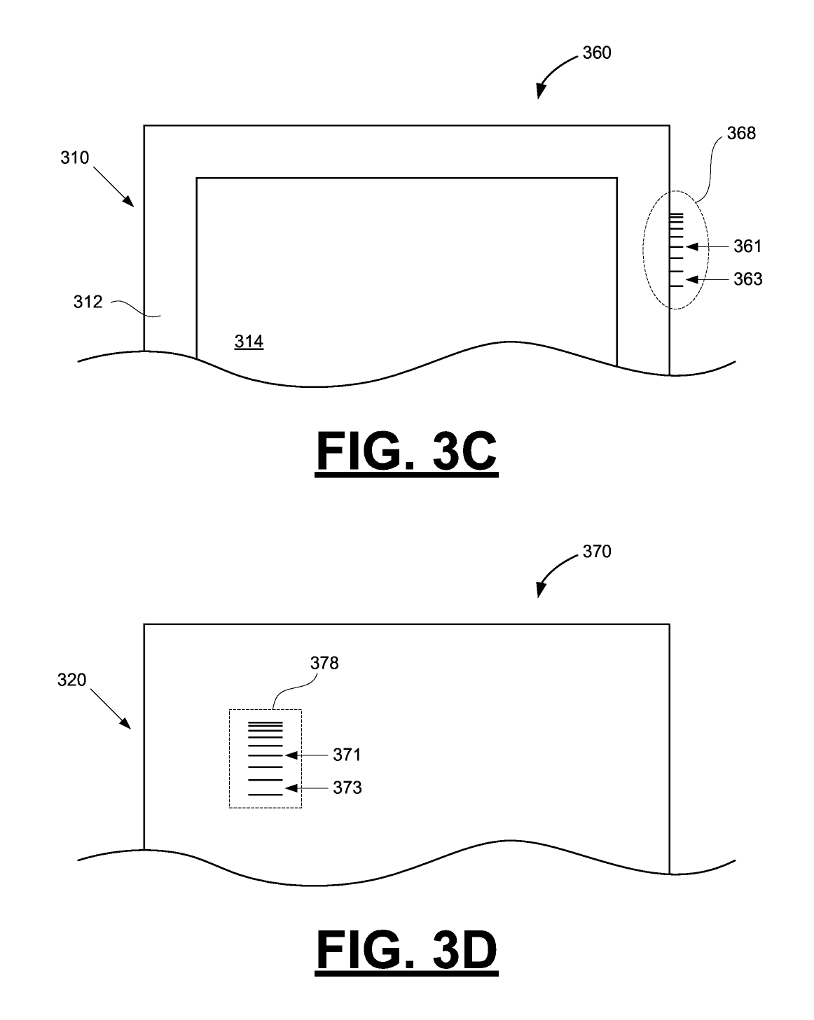

FIG. 3A is a frontal view of an e-reader device 300 having a tactile acoustic input mechanism, in accordance with some embodiments. The e-reader device 300 includes a housing 310 having a front bezel 312 and a display screen 314. The e-reader device 300 can be substantially tabular or rectangular, so as to have a front surface that is substantially occupied by the display screen 314 so as to enhance content viewing. The display screen 314 can be part of a display assembly, and can be touch sensitive. For example, the display screen 314 can be provided as a component of a modular display assembly that is touch-sensitive and integrated with housing 310 during a manufacturing and assembly process.

According to examples described herein, the e-reader device 300 includes a tactile interface 318 provided on a side surface or edge of the housing 310. In an embodiment, the tactile interface 318 may be integrally formed with (e.g., molded into) the housing 310, for example, during a manufacturing processes. Alternatively, the tactile interface 318 may be superimposed on, or attached to (e.g., using an adhesive), the surface of the housing 310, for example, during an assembly process. The tactile interface 318 is made of a material (such as aluminum, plastic, and/or whatever material the housing 310 is made from) that produces sound by resonating or vibrating in response to user touch. Further, the tactile interface 318 can include a number of discrete peaks 311 and valleys 313 that produce a distinct sound (e.g., sequence of tones) when swiped or otherwise touched, in succession, by a user. The peaks 311 and valley 313 may be of varying size, shape, degree, arrangement, and/or pitch, for example, to produce different sounds depending on the direction of swiping.

In an example, the peaks 311 are of varying heights and arranged in order of decreasing magnitude to produce a different sound when the tactile interface 318 is swiped in a downward motion as when the tactile interface 318 is swiped in an upward motion. Specifically, taller peaks 311 (e.g., those towards the top of the tactile interface 318) are likely to resonate louder and/or longer than shorter peaks 311 (e.g., those towards the bottom of the tactile interface 318). As a result, an upward swiping action may be accompanied by a crescendo of sound, whereas a downward swiping action may be followed by a decrescendo of sound. This provides directionality to the sound (i.e., acoustic signals) produced by the tactile interface 318, and may thus enable the e-reader device 300 to distinguish between user inputs corresponding to upward and downward swiping motions.

FIG. 3B is a rear view of an e-reader device 350 having a tactile acoustic input mechanism, in accordance with other embodiments. The e-reader device 350 includes a housing 320 and a tactile interface 328 provided on a back surface of the housing 320. As described above, the tactile interface 328 can be made from a resonant material (e.g., aluminum or plastic) that is integrally formed with the housing 320 or, alternatively, is superimposed on the surface of the housing 320. The tactile interface 328 is further made up of a number of peaks 321 and valleys 323 (e.g., of varying size, shape, degree arrangement, and/or pitch) that produce a distinct sound when swiped or otherwise touched by a user.

In an example, the peaks 321 are of varying lengths and arranged in order of decreasing magnitude to produce a different sound when the tactile interface 328 is swiped in a downward motion as when the tactile 328 is swiped in an upward motion. Specifically, wider peaks 321 (e.g., those towards the top of the tactile interface 328) are likely to resonate louder and/or longer than narrower peaks 321 (e.g., those towards the bottom of the tactile interface 328). As a result, an upward swiping action may be accompanied by a crescendo of sound, whereas a downward swiping action may be followed by a decrescendo of sound. This further provides directionality to the sound (i.e., acoustic signals) produced by the tactile interface 318, and may be indicative of a particular type of interaction with the tactile interface 318.

FIG. 3C is a frontal view of an e-reader device 360 having a tactile acoustic input mechanism, in accordance with other embodiments. According to examples described herein, the e-reader device 360 includes a tactile interface 368 provided on the side surface or edge of the housing 310. As described above, the tactile interface 368 includes a number of discrete peaks 361 and valleys 363 that produce a distinct sound when swiped. In an example, the peaks 361 are arranged in a non-periodic configuration. Specifically, the distances between peaks 361 (i.e., the widths of the valleys 363) towards the top of the tactile interface 368 are shorter than the distances between peaks 361 towards the bottom of the tactile interface 368. In other words, the tactile interface 368 has a finer pitch up top than at the bottom. As a result, swiping the tactile interface 368 may produce a “chirping” sound with varying harmonics, depending on the direction of the swipe (e.g., upward or downward swiping motion). The e-reader device 300 may therefore determine the directionality of the acoustic signals produced by the tactile interface 368 based on sound harmonics.

FIG. 3D is a rear view of an e-reader device 370 having a tactile acoustic input mechanism, in accordance with other embodiments. According to examples described herein, the e-reader device 370 includes a tactile interface 378 provided on the back surface of the housing 320. As described above, the tactile interface 378 includes a number of discrete peaks 371 and valleys 373 that are arranged in a non-periodic configuration, to produce a distinct sound when swiped. Specifically, the tactile interface 378 has a finer pitch towards the top than towards the bottom. As a result, swiping the tactile interface 368 may produce a chirping sound with varying harmonics, depending on the direction of the swipe (e.g., upward or downward swiping motion). The e-reader device 370 may therefore determine the directionality of the acoustic signals produced by the tactile interface 378 based on sound harmonics.

While examples of FIGS. 3A-3D illustrate a few possible configurations for the placement and/or design of a tactile interface, variations provide for tactile interfaces having peaks and valleys of any combination of size (e.g., length, width, and/or height), shape, degree, arrangement, and/or pitch in order to produce unique sounds that are distinguishable from one another depending on a direction of swiping. For some embodiments, the peaks and valleys may be arranged in a grid pattern such that leftward and rightward swiping sounds are distinguishable from upward and downward swiping sounds. Furthermore, the tactile interface can be provided at any location, on any surface of the housing, such that the tactile interface is operable by a user (e.g., using one or two hands). Other embodiments contemplate the placement of multiple tactile interfaces on the same e-reader device (e.g., one on the side surface and one of the back surface of the housing). For example, each tactile interface may be an exact copy of the other, and may therefore provide more accessibility options (e.g., in the form of redundancy) to the user. In another example, one tactile interface may be different from another (e.g., produce different sounds when swiped), and may thus allow for greater degree (e.g., more types) of user inputs.

Additionally, an e-reader device can be equipped to detect multiple, simultaneous, acoustic signals (e.g., produced from multiple tactile interfaces, concurrently). For example, the e-reader device can interpret simultaneous or concurrent acoustic signals as a single, combined, input. In such an example, the concurrent swiping action can be interpreted as a specific type of input (e.g., page-turning action) or as a general input (e.g., user detection).

Examples of FIGS. 3A-3D illustrate respective embodiments which enable and/or facilitate single-handed operation of an e-reader device. More specifically, the embodiments herein allow a user to interact with an e-reader device (e.g., using a finger) to facilitate activities such as page or chapter flipping while holding the device with the same hand. Moreover, by leveraging existing resources of the e-reader device (such as an all-purpose microphone), the embodiments described herein may be implemented with minimal changes (if any) to the hardware of the device. For example, the tactile interface used to generate or produce user inputs may be applied to the housing of existing e-reader devices (i.e., apart from the manufacturing process). Alternatively, the tactile interface may be provided as a separate or stand-alone feature to be used in connection with existing e-reader devices.

Acoustic Interface

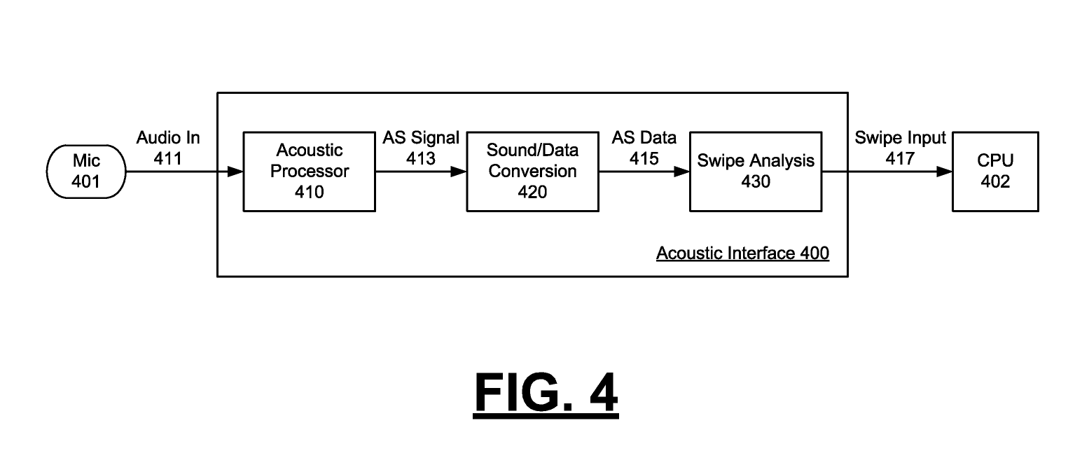

FIG. 4 illustrates an acoustic interface 400 for detecting and processing acoustic signals, according to one or more embodiments. The acoustic interface 400 can be implemented by the e-reader device 110 (see FIG. 1) or other end-user device. Accordingly, reference may be made to elements of FIG. 1 for purpose of illustrating an operational environment of the acoustic interface 400. In an example of FIG. 4, the acoustic interface 400 can be operated to receive and process an acoustic signal corresponding to a particular type of user input, according to an embodiment. In more detail, the acoustic interface 400 includes an acoustic processing component 410, a sound-to-data conversion component 420, and a swipe analysis component 430.

The acoustic processing component 410 receives an audio input 411 from a microphone 401. As described above, the microphone 401 can correspond to an off-the-shelf, non-specialized component that can receive any form of audio or acoustic input, including voice input or ambient noise. The acoustic processing component 410 can treat the audio input 411 to identify an acoustic signal 413 that has detectable modulating characteristics (e.g., amplitude and/or wavelength). The sound/data conversion component 420 can process the acoustic signal 413 in order to determine acoustic data 415. For example, the sound/data conversion component 420 may correspond to and/or include an analog-to-digital converter (ADC) that samples and converts the analog acoustic signal 413 to digital data (i.e., acoustic data 415).

The swipe analysis component 430 analyzes the acoustic data 415 to determine one or more characteristics of the acoustic signal 413. For example, as described above, different acoustic signals can be produced by the tactile interface 132 in response to different swiping motions (e.g., an upward swipe may produce a different “sound” than a downward swipe). In addition, a faster swipe may produce a shorter burst of sound, whereas a slower swipe produces a longer stream of sound. Thus, the swipe analysis component 430 may determine a directionality of the swiping motion associated with the acoustic signal 413, for example, based on amplitude changes or modulation of the acoustic signal 413. In addition, the swipe analysis component 430 may determine a degree or magnitude of the swiping motion associated with the acoustic signal 413, for example, based on a length or duration of the acoustic signal 413.

The swipe analysis component 430 converts the acoustic data 415 to a swipe input 417 including direction and/or magnitude parameters (e.g., corresponding to the direction/magnitude of a corresponding swiping action). The swipe input 417 may be provided to a CPU 402 for further processing. The CPU 402 may interpret the swipe input 417 as a command or instruction for performing a particular action. In an embodiment, the CPU 402, in implementing page transitioning logic 115, can interpret the swipe input 417 as a page-turning action.

Page Transition Functionality

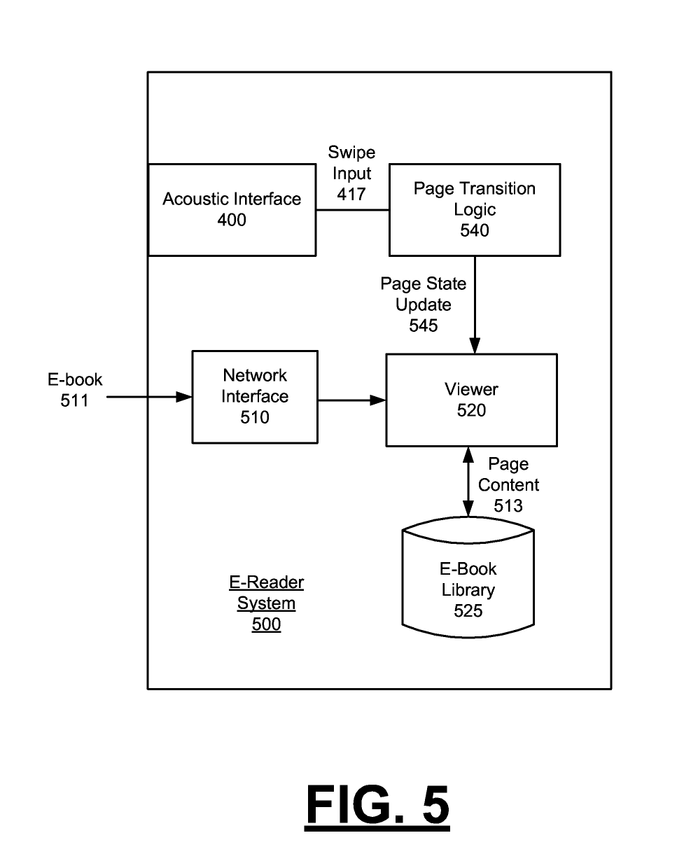

FIG. 5 illustrates an e-reader system for displaying page content, according to one or more embodiments. An e-reader system 500 can be implemented as, for example, an application or device, using components that execute on, for example, an e-reader device such as shown with examples of FIGS. 1, 2, 3A and 3B. Furthermore, an e-reader system 500 such as described can be implemented in a context such as shown by FIG. 1, and configured as described by an example of FIG. 2 and FIG. 3.

In an example of FIG. 5, a system 500 includes a network interface 510, a viewer 520 and page transition logic 540. As described with an example of FIG. 1, the network interface 510 can correspond to a programmatic component that communicates with a network service in order to receive data and programmatic resources. For example, the network interface 510 can receive an e-book 511 from the network service that the user purchases and/or downloads. E-books 511 can be stored as part of an e-book library 525 with memory resources of an e-reader device (e.g., see memory 250 of e-reader device 200).

The viewer 520 can access page content 513 from a selected e-book, provided with the e-book library 525. The page content 513 can correspond to one or more pages that comprise the selected e-book. The viewer 520 renders one or more pages on a display screen at a given instance, corresponding to the retrieved page content 513. The page state can correspond to a particular page, or set of pages that are displayed at a given moment.

The page transition logic 540 can be provided as a feature or functionality of the viewer 520. Alternatively, the page transition logic 540 can be provided as a plug-in or as independent functionality from the viewer 520. The page transition logic 540 can signal page state updates 545 to the viewer 520. The page state update 545 can specify a page transition, causing the viewer 520 to render a new page. In specifying the page state update 545, the page transition logic 540 can provide for single page turns, multiple page turns or chapter turns. The page state update 545 for a single page turn causes the viewer 520 to transition page state by presenting page content 513 that is next in sequence (forward or backward) to the page content that is being displayed. The page state update 545 for a multi-page turn causes the viewer 520 to transition page state by presenting page content 513 that is a jump forward or backward in sequence from the page state under display. Likewise, the page state update 545 for a chapter turn causes the viewer 520 to transition page state by presenting page content 513 that is a next chapter in sequence (forward or backward) to a chapter of a current page state. Accordingly, the page state update 545 can signify a transition value representing the page state that is to be displayed next (e.g., one page transition or ten page transition) or a transition type (e.g., page versus chapter transition).

According to some embodiments, the page transition logic 540 can be responsive to different kinds of input, including the swipe input 417 generated by acoustic interface 400, which signifies page turns (or page transitions). The swipe input 417 can signify, for example, single-page turns, mufti-page turns or chapter turns. The type of page turn or transition can be determined from the parameters (e.g., direction and/or magnitude) of the swipe input 417. As described above, for example, the swipe input 417 can be derived from an acoustic signal produced by a tactile interface in response to a user interacting with (e.g., swiping) the tactile interface. Accordingly, the swipe input 417 may specify or otherwise indicate the direction of the swiping action (e.g., up, down, left, or right) and/or the magnitude of the swipe (e.g., fast or slow). Likewise, other input such as touch and hold can be interpreted as a mufti-page turn or chapter input. Still further, actions such as a tap and swipe can be interpreted as a chapter transition.

In response to receiving a swipe input 417, the page transition logic 540 signals the page state update 545 to the viewer 520. In an embodiment, the page transition logic 540 can interpret the direction of the swipe input 417 as a page-turning direction. For example, the page transition logic 540 may associate a downward swipe direction with a forward page-turn instruction. The page transition logic 540 may further associate an upward swipe direction with a backward page-turn instruction. Further, in an embodiment, the page transition logic 540 can interpret the magnitude of the swipe input 417 as a single-page, mufti-page, or chapter transition instruction. For example, the page transition logic 540 may associate a slow (or normal) swipe speed with a single page turn. The page transition logic 540 may further associate faster swipe speeds with multiple page turns (e.g., wherein the number of pages transitioned depends on the speed of the swipe). The viewer 520 then updates the page content 513 to reflect the change represented by the page state update 545 (e.g., single page transition, multi-page transition, or chapter transition).

Methodology

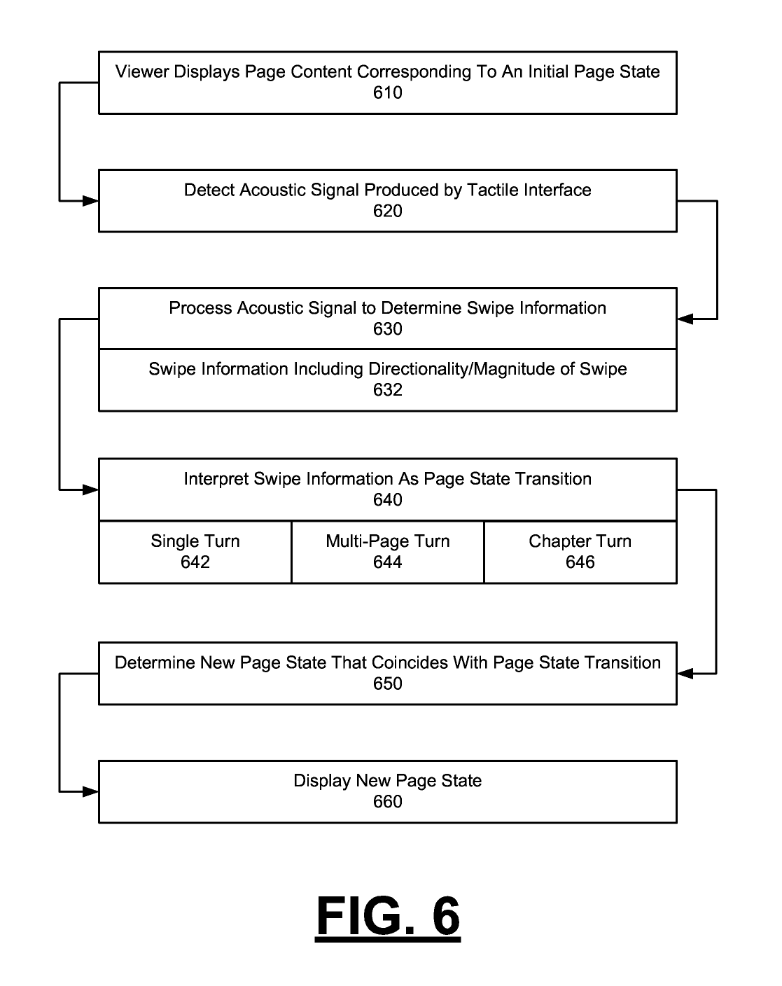

FIG. 6 illustrates a method for displaying paginated content, according to one or more embodiments. In describing an example of FIG. 6, reference may be made to components such as described with FIGS. 4 and 5 for purposes of illustrating suitable components for performing a step or sub-step being described.

With reference to an example of FIG. 5, the viewer 520 displays page content corresponding to an initial page state (610). For example, the viewer 520 can display a single page corresponding to the page being read by the user, or alternatively, display multiple pages side-by-side to reflect a display mode preference of the user.

The e-reader device 500 can then detect (e.g., via the acoustic interface 400) an acoustic signal produced by a tactile interface provided on, or within acoustic range of, the device 500 (620). For example, the acoustic processing component 410 can detect acoustic signals 413 from the audio input 411 received by a microphone 401. More specifically, the acoustic processing component 410 may treat the audio input 411 to identify the acoustic signal 413 based on known, detectable modulating characteristics (e.g., amplitude and/or wavelength).

The acoustic signal is then processed to determine swipe information (630). The swipe information can include, for example, a directionality and/or magnitude of the swiping action associated with the received acoustic signal (632). For example, the sound/data conversion component 420 can sample and convert the received acoustic signal 413 into digital data (e.g., acoustic data 415). The swipe analysis component 430 can then analyze the acoustic data 415 to determine one or more characteristics of the acoustic signal 413. As described above, different acoustic signals can be produced by the tactile interface in response to different swiping motions. In particular, the swipe analysis component 430 may determine a directionality (e.g., based on amplitude changes or signal modulation) and/or magnitude (e.g., based signal length or duration) of the swiping motion associated with the acoustic signal 413.

The swipe information can be further interpreted in order to enable a page state transition (640). The swipe information can signify one or more of a single-page turn (642), a multi-page turn (644), or a chapter turn (646). For example, page transition logic 540 can receive swipe input 417 from the acoustic interface 400 and map the information provided with the swipe input 417 to a particular type of page state transition. In particular, the direction of the swipe input 417 (e.g., upward or downward) may be interpreted as a page-turning direction (e.g., backward or forward). Further, the magnitude of the swipe input 417 (e.g., fast or slow) may be interpreted as a single-page, multi-page, or chapter transition instruction. Still further, additional directionality information included with the swipe input 417 (e.g., leftward or rightward) may be interpreted as a chapter-turning direction (e.g., backward or forward).

Upon determining the type of page-state transition to be performed, e-reader device 500 determines a new page state that coincides with the page state transition (650). The new page state is then displayed on the viewer 520 of the e-reader device 500 (660). For example, the page transition logic 540 can signal a corresponding page state update 545 to the viewer 520 in response to the swipe input 417. Thus, where the swipe input 417 signifies a single page turn, the page state update 545 may specify a forward or backward page turn. Where the swipe input 417 signifies a mufti-page turn, the page state update 545 may specify a number of pages to skip forward or jump back to. Where the swipe input 417 signifies a chapter change, the page state update 545 may specify a forward or backward chapter jump.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a housing;
a display assembly including a screen, wherein the housing at least partially circumvents the screen so that the screen is viewable;
a tactile interface provided on a surface of the housing, wherein the tactile interface is to produce a plurality of acoustic signals based on user interactions;
an audio input device provided with a portion of the housing, wherein the audio input device is to detect the acoustic signals produced by the tactile interface; and
a processor provided within the housing, the processor operating to:
display at least a portion of an initial page state for a paginated content item;
interpret the plurality of acoustic signals produced by the tactile interface as a plurality of user inputs, respectively, wherein one or more acoustic signals of a first type correspond with a page transition instruction; and
respond to acoustic signals of the first type by transitioning from displaying at least the initial page state to displaying another page state as determined by a value or type of the page transition.

2. The computing device of claim 1, wherein the tactile interface comprises a plurality of peaks and valleys to produce the plurality of acoustic signals in response to the user interactions.

3. The computing device of claim 2, wherein the plurality of peaks and valleys are configured in a grid pattern that enables the tactile interface to produce different acoustic signals in response to different user interactions.

4. The computing device of claim 3, wherein the user interactions comprise finger swipes in one or more directions.

5. The computing device of claim 4, wherein the plurality of peaks and valleys are of varying degree or size such that, when swiped, the tactile interface produces an acoustic signal which indicates a directionality of the finger swipe.

6. The computing device of claim 5, wherein the processor is to further:
interpret the acoustic signal produced by a finger swipe in a first direction as a forward page transition instruction; and
respond to the forward page transition instruction by transitioning from displaying the initial page state to displaying a subsequent page state.

7. The computing device of claim 6, wherein the processor is to further:
interpret the acoustic signal produced by a finger swipe in a second direction as a backward page transition instruction; and
respond to the backward page transition instruction by transitioning from displaying the initial page state to displaying a previous page state.

8. The computing device of claim 7, wherein the second direction is opposite the first direction.

9. The computing device of claim 1, wherein the tactile interface is provided on a back surface of the housing.

10. The computing device of claim 1, wherein the tactile interface is provided on a side surface of the housing.

11. The computing device of claim 1, wherein the tactile interface is superimposed onto the surface of the housing.

12. The computing device of claim 1, wherein the tactile interface is integrally formed with the surface of the housing.

13. A method for operating a computing device, the method being implemented by one or more processors and comprising:
displaying at least a portion of an initial page state for a paginated content item;
interpreting a plurality of acoustic signals produced by a tactile interface of the computing device as a plurality of user inputs, respectively, wherein one or more acoustic signals of a first type correspond with a page transition instruction; and
responding to acoustic signals of the first type by transitioning from displaying at least the initial page state to displaying another page state as determined by a value or type of the page transition.

14. The method of claim 13, wherein the tactile interface comprises a plurality of peaks and valleys to produce the plurality of acoustic signals based on user interactions.

15. The method of claim 14, wherein the plurality of peaks and valleys are configured in a grid pattern that enables the tactile interface to produce different acoustic signals in response to different user interactions.

16. The method of claim 15, wherein the user interactions comprise finger swipes in one or more directions.

17. The method of claim 16, wherein the plurality of peaks and valleys are of varying degree or size such that, when swiped, the tactile interface produces an acoustic signal which indicates a directionality of the finger swipe.

18. The method of claim 17, further comprising:
interpreting the acoustic signal produced by a finger swipe in a first direction as a forward page transition instruction; and
responding to the forward page transition instruction by transitioning from displaying the initial page state to displaying a subsequent page state.

19. The method of claim 18, further comprising:
interpreting the acoustic signal produced by a finger swipe in a second direction as a backward page transition instruction, wherein the second direction is opposite the first direction; and
responding to the backward page transition instruction by transitioning from displaying the initial page state to displaying a previous page state.

20. A non-transitory computer-readable medium that stores instructions, that when executed by one or more processors, cause the one or more processors to perform operations that include:
displaying at least a portion of an initial page state for a paginated content item;
interpreting a plurality of acoustic signals produced by a tactile interface of the computing device as a plurality of user inputs, respectively, wherein one or more acoustic signals of a first type correspond with a page transition instruction; and
responding to acoustic signals of the first type by transitioning from displaying at least the initial page state to displaying another page state as determined by a value or type of the page transition.
